(19) United States
(12) Patent Application Publication
(10) Pub. No.: US 2020/0047068 A1
(43) Pub. Date: Feb. 13, 2020

(54) EXERCISE DEVICE ELECTRICALLY COUPLED TO A COMPUTING DEVICE FOR POWERING THE COMPUTING DEVICE AND QUANTIFY THE PLAY OF A VIDEO GAME ASSOCIATED WITH THE COMPUTING DEVICE

(71) Applicant: Nissim Amar, New Rochelle, NY (US)

(72) Inventor: Nissim Amar, New Rochelle, NY (US)

(21) Appl. No.: 16/058,064

(22) Filed: Aug. 8, 2018

(51) Int. Cl. A63F 13/42; A63B 24/00; A63B 22/06; A63F 13/21; A63F 13/235; A63F 13/57; A63F 13/65; A63F 13/803; A63F 13/816

(52) U.S. Cl. CPC A63F 13/42; A63B 2225/50; A63B 24/0062; A63B 22/0605; A63F 13/21; A63F 13/235; A63F 13/57; A63F 13/65; A63F 13/803; A63F 13/816; A63B 2024/0096; A63B 2220/20; A63B 2220/17; A63B 2022/0635; A63B 2230/01; A63B 24/0087

(57) ABSTRACT

An exercise device electrically coupled to a computing device for powering the computing device and quantify the play of the coupled video game through a video gaming software application is provided. The exercise device is adapted with an electromechanical energy conversion element for producing electrical power for the computing device. Also integrated to the exercise device may be one or more sensors sensing data that the video gaming software application may use to interact with or otherwise quantify the play of the video game, thereby providing incentives to encourage sustained play and, as a corollary, exercise of the user

### BACKGROUND OF THE INVENTION

The present invention relates to video game devices combined with and an exercise device and, more particularly, to an exercise device electrically coupled to a computing device for powering the computing device and quantify the play of a video game associated with the computing device.

Though some current video gaming devices like Wii™, Play Station™ or Xbox™ do incorporate a user's physical motion in the resulting video game, the use is still required to either sitt or stand in front of a TV or other video output device in order to play such devices, no matter the game. In other words, all these devices are not mobile and do not offer a significant exercise. Moreover, they do not offer a bicycle or a pedaling accessories to any of their games.

As can be seen, there is a need for an exercise device electrically coupled to a computing device for powering the computing device and quantify the play of the coupled video game, wherein the exercise device is adapted with a electromechanical energy conversion element for producing electrical power for the computing device, as well as data that quantifies the play of the video game, thereby providing incentives to encourage sustained play and, as a corollary, exercise of the user.

In other words, each user will need to pedal spin or bike on a stationary pedaling device in order to play a variety of games on their computing devices, while doing so they will get exercise and live a healthier life

There is nothing like the present invention in either the bike market or the game market. Moreover, the present invention will be compact and mobile so a user can play it in the car, on the way to school, at home, or in any other situation while the user is in a sitting position. In certain embodiments, the present invention will work on either battery-power source or the actual pedaling of the player.

### SUMMARY OF THE INVENTION

In one aspect of the present invention, a system operatively associating an exercise device and a computing device includes an electromechanical energy conversion element configured so that in order to power the computing device mechanical work must be applied to the exercise device.

In another aspect of the present invention, the system operatively associating an exercise device and a computing device having a user interface further including one or more sensors operatively associated with the exercise device, each sensor adapted to sense one or more data sets regarding the operation of the exercise device; and a video game software application loaded on the computing device, the video game software application coupled to the one or more sensors so that one or more of the data sets is input of a video game electronically represented on the user interface, wherein the exercise device is a bicycle exercise device, and wherein the one or more data sets includes an effective distance pedaled and/or revolutions per minute pedaled on the bicycle exercise device.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a schematic view of an exemplary embodiment of the present invention;

FIG. 3 is a systemic flow chart of an exemplary embodiment of the present invention; and

FIG. 4 is a user flow chart view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an exercise device electrically coupled to a computing device for powering the computing device and quantifying the play of the coupled video game through a video gaming software application. The exercise device is adapted with an electromechanical energy conversion element for producing electrical power for the computing device. Also integrated to the exercise device may be one or more sensors sensing data that the video gaming software application may use to interact with or otherwise quantify the play of the video game, thereby providing incentives to encourage sustained play and, as a corollary, exercise of the user.

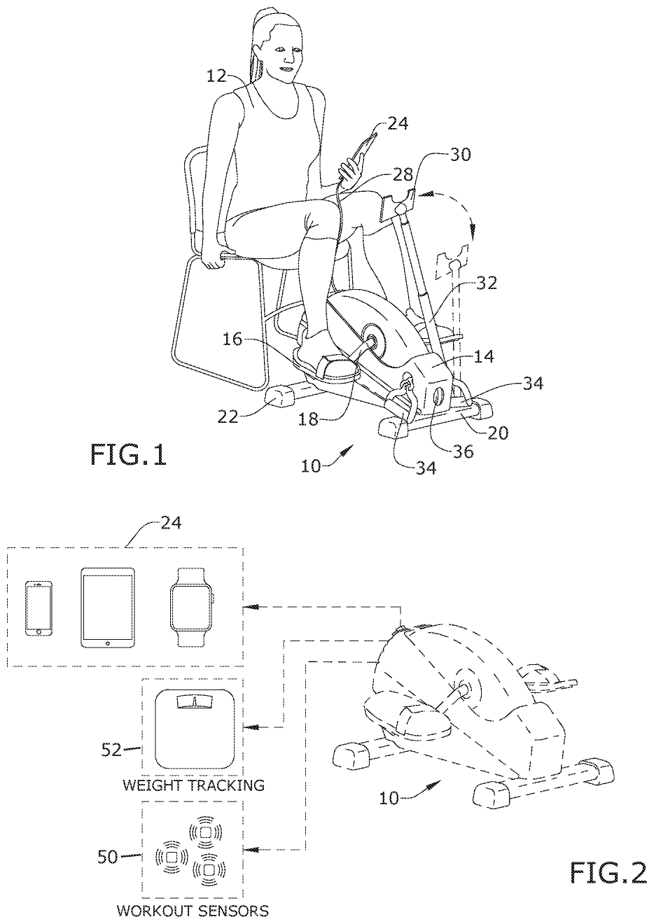

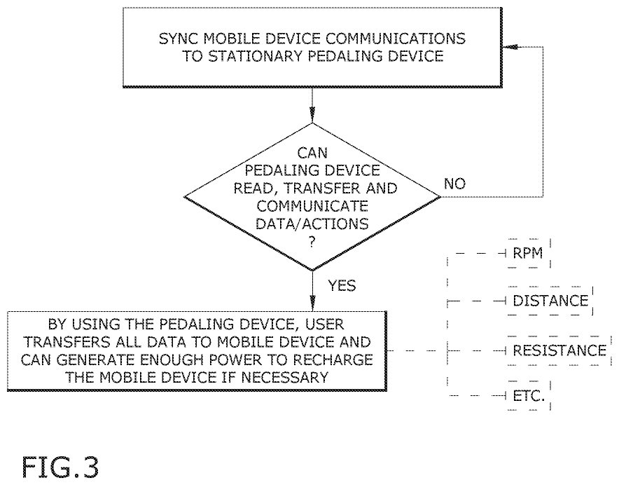

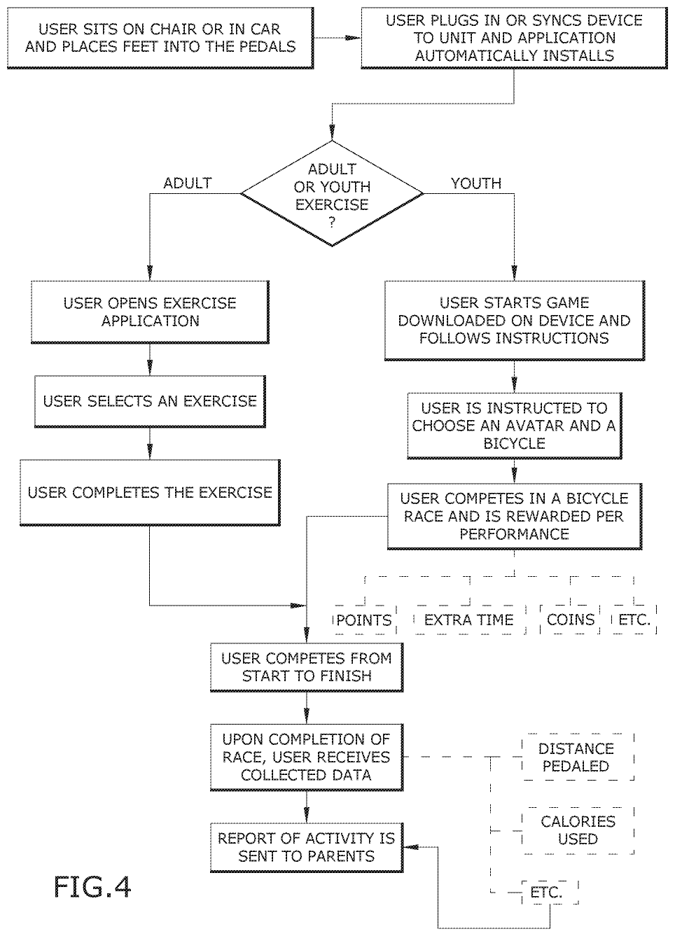

Referring to FIGS. 1 through 4, the present invention may include an exercise device 10 coupled to a computing device 24. The computing device 24 may include a user interface. The computing device 24 may include at least one processing unit coupled to a form of memory including, but not limited to, a desktop, laptop, and smart device, such as, a tablet and smart phone. The computing device 24 includes a program product including a machine-readable program code for causing, when executed, the computing device 24 to perform steps. The program product may include software which may either be loaded onto the computing device 24 or accessed by the computing device 24. The loaded software may include an application on a smart device. The software may be accessed by the computer using a web browser. The computing device 24 may access the software via the web browser using the internet, extranet, intranet, host server, Internet cloud and the like.

The exercise device 10 could be an exercise bicycle, a rowing machine, or other type of seated or non-seated exercise device (such as a cross-country skiing machine), even though an exercise bicycle is what is shown. The exercise bicycle or pedaling device may have a housing 14 housing a resistance/gear mechanism (not shown) and electromechanical energy conversion element (not shown) rotatably connected to two opposing crank arms 18. Each crank arm 18 may provide a pedal 16 for a user 12 to operatively engage in a seated position, as illustrated in FIG. 1. The electromechanical energy conversion element may be adapted to convert the mechanical work of the user 12 pedaling into electrical power.

The housing 14 may have a fixed leg 20 and an adjustable leg 22 to provide stability and comfort to the user 12. The housing may provide a computing device holder 30, dimensioned and adapted to removably secure the computing device 24 during use. The computing device holder 30 may be connected to the housing 14 by way of a holder arm 32. The holder arm 32 may be pivotally connected to the housing 14 to move among many different positions so as to facilitate use and mounting and dismounting the exercise device 10. In certain embodiments, the holder arm 32 may be telescopic so as move between an extended position and a retract position, for similar reasons. The exercise device 10 may be dimensioned and adapted to be portable. The housing 14 may provide additional exercise equipment, not coupled to the electromechanical energy conversion element, such as resistance band 34 with an operatively associated tension dial 36.

The exercise device 10 may provide one or more electronic output sensors 50 adapted to senses the speed at which the bicycle is pedaled, RPM, distance, resistance level and/or the power generated via the electromechanical energy conversion element. The exercise device 10 may provide weight tracking 52 for informing the user 12 of weight losses and gains over selectable time intervals. The electromechanical energy conversion element may include an operatively coupled rechargeable dynamo and/or power source (not shown) for retrievably storing the electrical power/energy of the electromechanical energy conversion element. The exercise device 10 may provide a port (not shown) that can operatively associate the electromechanical energy conversion element to a power interface cable 28, e.g., a USB connection, which in turn may be operatively associated with the computing device 24. The computing device 24 may provide a video game software application, in certain embodiments pre-installed thereon. The video game software application may provide one or more bike/bicycle games wherein the output signal from the one or more electronic sensor 50 affects/quantifies the play of the resulting video game. A communication device (not shown) may be integrated with the exercise device 10 to control video game software application functions and synchronized with a pedaling consul, wherein the communication device is adapted to read, transfer and communicate the user's 12 actions/performance onto the video game software application. The communication device may use wireless communication, such as Bluetooth™ functionality or the like. The user interface of the computing device 24 may, through the video game software application, electronically represent the players actions thereon.

A method of using the present invention may include the following. The exercise device 10 and computing device 24 disclosed above may be provided. The user 12 may start a game on the computing device 24, which may be a bicycle race video game. From there, the video game software application may be adapted to instructed the user 12 to pick the color, bike type, player avatar, etc. Next the user 12 may be directed to pedal with his feet via the exercise device 10 to the start line. Once the race begins the user's 12 goal is to win the race by pedaling according to the terrain hard or soft fast or slow. The electronic sensors 50 integrated to the exercise device 10 may convert the user's 12 efforts into readable data associated with the video game software application and representable on the user interface of the computing device 10. Each game on each turn may be limited by game time and number of tries allowed to complete each step or stage of the game. The rechargeable power source may also allow the additional batteries to be charged in the case that the device is being used without being connected to an external power source.

Thereby, the user 12 may sit on a chair or in the car or at he's desk at school at home or at work, insert he's/her feet on top of the pedals, start a game on he's/her mobile device, follow the instructions on the screen on how to play, be instructed to choose an avatar of a player and a bicycle, and to pedal to the start line. Then the user 12 may compete on in virtual bicycle races while playing he may be rewarded with points, extra playtime, coins, or other rewards. The game may be on a set time from start to finish. Also, the user 12 may be given a few turns or “lives” to complete one game. At the finish of each game, the user 12 may be able to read the resulting data of the screen/user interface of the computing device 24. Per the electronic sensors 50 and the video game software application, the output and resulting data such as distance peddled and calories used may be electronically represented on the user interface of the computing device 24. Also, the user 12 may be rewarded with coins added to their profile or other methods used in video games, that they may be able to use to purchase or get discount on purchases from designated online store.

The objective of this invention is to encourage mostly children (adults as well) of all ages and all genders to preform light and easy exercise while spending time on their computing devices 24, which they are (too) frequently on. The video game software application used will allow parents to receive a report on the daily activity of the child; i.e. time spent, distance accomplished and number of estimated calories used.

The computing-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computing device 24. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system operatively associating an exercise device and a computing device, comprising:
an electromechanical energy conversion element configured so that in order to power the computing device mechanical work must be applied to the exercise device.

2. The system of claim 1, wherein the exercise device is a bicycle exercise device.

3. The system of claim 2, wherein the computing device is a video game.

4. A system operatively associating an exercise device and a computing device having a user interface, comprising:
one or more sensors operatively associated with the exercise device, each sensor adapted to sense one or more data sets regarding the operation of the exercise device; and
a video game software application loaded on the computing device, the video game software application coupled to the one or more sensors so that one or more of the data sets is input of a video game electronically represented on the user interface.

5. The system of claim 4, wherein the exercise device is a bicycle exercise device.

6. The system of claim 5, wherein the one or more data sets includes an effective distance pedaled and/or revolutions per minute pedaled on the bicycle exercise device.

7. The system of claim 6, further comprising an electromechanical energy conversion element configured so that in order to power the computing device mechanical work must be applied to the bicycle exercise device.
